(19) United States
(12) Patent Application Publication
(10) Pub. No.: US 2025/0266767 A1
(43) Pub. Date: Aug. 21, 2025

(54) BUCK-BOOST DC-DC CONVERTER CIRCUIT AND CORRESPONDING METHOD OF OPERATION

(71) Applicant: STMicroelectronics S.r.l., Agrate Brianza (MB) (IT)

(72) Inventors: Nunzio Greco, Camporotondo Etneo (IT); Osvaldo Enrico Zambetti, Milano (IT); Ranieri Guerra, S. Giovanni La Punta (CT) (IT); Francesca Giacoma Mignemi, S. Giovanni La Punta (CT) (IT)

(21) Appl. No.: 19/200,465

(22) Filed: May 6, 2025

Related U.S. Application Data
(63) Continuation of application No. 18/297,998, filed on Apr. 10, 2023, now Pat. No. 12,323,060.

(30) Foreign Application Priority Data
Apr. 22, 2022 (IT) 102022000008108

(51) Int. Cl. H02M 3/158; H02M 1/00; H02M 3/157

(52) U.S. Cl. CPC H02M 3/1582; H02M 1/0016; H02M 3/157

(57) ABSTRACT

A buck-boost converter circuit includes a mode selection circuit that asserts a buck enable signal if an input voltage is higher than a lower threshold, and asserts a boost enable signal if the input voltage is lower than an upper threshold. A control circuit asserts a buck PWM signal upon a pulse in a buck clock and de-asserts the buck PWM signal if a buck ramp is higher than a buck control signal, and it keeps the buck PWM signal asserted if the buck enable signal is de-asserted. The control circuit asserts a boost PWM signal upon a pulse in a boost clock and de-asserts the boost PWM signal if a boost ramp is higher than a boost control signal, and it keeps the boost PWM signal de-asserted if the boost enable signal is de-asserted.

### CROSS-REFERENCE TO RELATED APPLICATIONS

This application is a continuation of U.S. application Ser. No. 18/297,998, filed on Apr. 10, 2023, which claims priority to Italian Patent Application No. 102022000008108, filed on Apr. 22, 2022, which application is hereby incorporated by reference herein in its entirety.

### TECHNICAL FIELD

The present disclosure relates to buck-boost DC-DC switching converters (e.g., non-inverting converters).

### BACKGROUND

Voltage converters are conventionally used in power management systems to convert a DC input voltage Vᵢₙ into a DC output voltage Vₒᵤₜ. Various topologies of switching mode power supply (SMPS) can be adopted to achieve high conversion efficiency. Buck converters provide a step-down conversion of the input voltage (i.e., Vₒᵤₜ<Vᵢₙ), and boost converters provide a step-up conversion (i.e., Vₒᵤₜ>Vᵢₙ). Non-inverting buck-boost converters are adopted when the output voltage Vₒᵤₜ can be higher or lower than the input voltage Vᵢₙ, thus enabling both step-up and step-down voltage conversion.

### SUMMARY

In one or more embodiments the present disclosure provides buck-boost DC-DC converters with improved efficiency and lower complexity.

One or more embodiments may relate to a corresponding method of operating a buck-boost DC-DC converter.

In one or more embodiments, a buck-boost DC-DC converter circuit includes a switching stage configured to receive a converter input voltage, a buck pulse-width modulated control signal and a boost pulse-width modulated control signal, and produce a converter output voltage as a function thereof. The converter includes an error amplifier circuit configured to sense the converter output voltage and a reference voltage, and produce an error signal indicative of a difference between the reference voltage and the converter output voltage. The converter includes an operation mode selection circuit configured to compare the converter input voltage to a lower threshold and an upper threshold.

The operation mode selection circuit is configured to assert a buck mode enable signal in response to the converter input voltage being higher than the lower threshold, and de-assert the buck mode enable signal in response to the converter input voltage being lower than the lower threshold. The operation mode selection circuit is configured to assert a boost mode enable signal in response to the converter input voltage being lower than the upper threshold, and de-assert the boost mode enable signal in response to the converter input voltage being higher than the upper threshold.

The converter includes a voltage shifter circuit configured to produce a buck control signal and a boost control signal as a function of the error signal, the buck mode enable signal, and the boost mode enable signal. The converter includes a ramp generator circuit configured to produce a buck ramp signal as a function of a buck clock signal and produce a boost ramp signal as a function of a boost clock signal. The converter includes a control circuit configured to compare the buck control signal to the buck ramp signal.

The control circuit is configured to assert the buck pulse-width modulated control signal in response to a pulse in the buck clock signal and de-assert the buck pulse-width modulated control signal in response to the buck ramp signal being higher than the buck control signal, provided that the buck mode enable signal is asserted. The control circuit is configured to keep the buck pulse-width modulated control signal asserted, provided that the buck mode enable signal is de-asserted. The control circuit is configured to compare the boost control signal to the boost ramp signal.

The control circuit is configured to assert the boost pulse-width modulated control signal in response to a pulse in the boost clock signal and de-assert the boost pulse-width modulated control signal in response to the boost ramp signal being higher than the boost control signal, provided that the boost mode enable signal is asserted. The control circuit is configured to keep the boost pulse-width modulated control signal de-asserted, provided that the boost mode enable signal is de-asserted. The voltage shifter circuit is configured to set V_{C,buck}=V_{EA}, where V_{C,buck} is the value of the buck control signal and V_{EA} is the value of the error signal, in response to the buck mode enable signal being asserted and the boost mode enable signal being de-asserted. The voltage shifter circuit is configured to set V_{C,boost}=(V_{EA}−V_{FF}), where V_{C,boost} is the value of the boost control signal, V_{EA} is the value of the error signal, and V_{FF} is the value of a feedforward voltage of the buck-boost DC-DC converter circuit, in response to the buck mode enable signal being de-asserted and the boost mode enable signal being asserted. The voltage shifter circuit is configured to set V_{C,buck}=(V_{EA}−k2·V_{ref1}) and V_{C,boost}=(V_{EA}−(k1+k2)−V_{ref1}), where V_{C,buck} is the value of the buck control signal, V_{EA} is the value of the error signal, V_{ref1} is the value of the reference voltage, V_{C,boost} is the value of the boost control signal, and k1 and k2 are values (e.g., constant values) that satisfy the conditions k1+2·k2=1 and 0<k1<1, in response to the buck mode enable signal being asserted and the boost mode enable signal being asserted.

One or more embodiments may thus provide a buck-boost DC-DC converter that automatically switches between buck, boost, and buck-boost operation modes with improved efficiency and low complexity.

In one or more embodiments, the voltage shifter circuit includes a voltage divider circuit including a first node, a second node, a third node, a fourth node, a first resistor coupled between the first node and the second node, a second resistor coupled between the second node and the third node, and a third resistor coupled between the third node and the fourth node. The first node is configured to produce the boost control signal, the second node is configured to produce the buck control signal, and the fourth node is configured to receive the error signal. The voltage shifter circuit includes a first current generator circuit configured to supply to the voltage divider circuit a current proportional to the feedforward voltage. The voltage shifter circuit includes a second current generator circuit configured to supply to the voltage divider circuit a current proportional to the reference voltage. The voltage shifter circuit includes a plurality of switches controllable by the buck mode enable signal and the boost mode enable signal. The plurality of switches are arranged to couple the voltage divider circuit to the first current generator circuit to receive the current proportional to the feedforward voltage in response to the buck mode enable signal being de-asserted; couple the voltage divider circuit to the second current generator circuit to receive the current proportional to the reference voltage in response to the buck mode enable signal being asserted; bypass the second resistor in response to the boost mode enable signal being de-asserted; and bypass the third resistor in response to the buck mode enable signal being asserted.

In one or more embodiments, the voltage shifter circuit includes a first voltage-to-current converter arrangement configured to sense the feedforward voltage and control the first current generator circuit, and a second voltage-to-current converter arrangement configured to sense the reference voltage and control the second current generator circuit.

In one or more embodiments, the ratio between the current produced by the first current generator circuit and the feedforward voltage is equal to 1/R, the ratio between the current produced by the second current generator circuit and the reference voltage is equal to 1/R, the first resistor has a resistance value equal to k1·R, the second resistor has a resistance value equal to k2·R, and the third resistor has a resistance value equal to (1−k1−k2)·R.

In one or more embodiments, the operation mode selection circuit comprises a voltage divider circuit configured to receive the converter input voltage and produce a first signal proportional to the converter input voltage and a second signal proportional to the converter input voltage. The proportionality factor of the first signal to the converter input voltage is higher than the proportionality factor of the second signal to the converter input voltage. The operation mode selection circuit comprises a first comparator configured to assert the buck mode enable signal in response to the first signal being higher than a further reference voltage, and de-assert the buck mode enable signal in response to the first signal being lower than the further reference voltage. The operation mode selection circuit comprises a second comparator configured to assert the boost mode enable signal in response to the further reference voltage being higher than the second signal, and de-assert the boost mode enable signal in response to the further reference voltage being lower than the second signal.

In one or more embodiments, the further reference voltage is linearly dependent on the reference voltage, or is proportional to the reference voltage, or is the same as the reference voltage.

In one or more embodiments, the control circuit includes a first comparator circuit configured to compare the buck control signal to the buck ramp signal, assert a buck comparison signal in response to the buck control signal being higher than the buck ramp signal, and de-assert the buck comparison signal in response to the buck control signal being lower than the buck ramp signal. The control circuit includes a second comparator circuit configured to compare the boost control signal to the boost ramp signal, assert a boost comparison signal in response to the boost control signal being higher than the boost ramp signal, and de-assert the boost comparison signal in response to the boost control signal being lower than the boost ramp signal. The control circuit includes a logic circuit configured to assert the buck pulse-width modulated control signal in response to the buck comparison signal being asserted and de-assert the buck pulse-width modulated control signal in response to the buck comparison signal being de-asserted, if the buck mode enable signal is asserted. The logic circuit is configured to assert the boost pulse-width modulated control signal in response to the boost comparison signal being asserted and de-assert the boost pulse-width modulated control signal in response to the boost comparison signal being de-asserted, if the boost mode enable signal is asserted.

According to another aspect of the present disclosure, a method of operating a buck-boost DC-DC converter circuit comprises receiving a converter input voltage, a buck pulse-width modulated control signal and a boost pulse-width modulated control signal, and producing a converter output voltage as a function thereof; sensing the converter output voltage and a reference voltage, and producing an error signal indicative of a difference between the reference voltage and the converter output voltage; comparing the converter input voltage to a lower threshold and an upper threshold; asserting a buck mode enable signal in response to the converter input voltage being higher than the lower threshold, and de-asserting the buck mode enable signal in response to the converter input voltage being lower than the lower threshold; asserting a boost mode enable signal in response to the converter input voltage being lower than the upper threshold, and de-asserting the boost mode enable signal in response to the converter input voltage being higher than the upper threshold; producing a buck control signal and a boost control signal as a function of the error signal, the buck mode enable signal and the boost mode enable signal; producing a buck ramp signal as a function of a buck clock signal and a boost ramp signal as a function of a boost clock signal; comparing the buck control signal to the buck ramp signal; if the buck mode enable signal is asserted, asserting the buck pulse-width modulated control signal in response to a pulse in the buck clock signal and de-asserting the buck pulse-width modulated control signal in response to the buck ramp signal being higher than the buck control signal; if the buck mode enable signal is de-asserted, keeping the buck pulse-width modulated control signal asserted; comparing the boost control signal to the boost ramp signal; if the boost mode enable signal is asserted, asserting the boost pulse-width modulated control signal in response to a pulse in the boost clock signal and de-asserting the boost pulse-width modulated control signal in response to the boost ramp signal being higher than the boost control signal; if the boost mode enable signal is de-asserted, keeping the boost pulse-width modulated control signal de-asserted; setting V_{C,buck}=V_{EA}, where V_{C,buck} is the value of the buck control signal and V_{EA} is the value of the error signal, in response to the buck mode enable signal being asserted and the boost mode enable signal being de-asserted; setting V_{C,boost}=(V_{EA}−V_{FF}), where V_{C,boost} is the value of the boost control signal, V_{EA} is the value of the error signal, and V_{FF} is the value of a feedforward voltage of the buck-boost DC-DC converter circuit, in response to the buck mode enable signal being de-asserted and the boost mode enable signal being asserted; and setting V_{C,buck}=(V_{EA}−k2·V_{ref1}) and V_{C,boost}=(V_{EA}−(k1+k2)·V_{ref1}), where V_{C,buck} is the value of the buck control signal, V_{EA} is the value of the error signal, V_{ref1} is the value of the reference voltage, V_{C,boost} is the value of the boost control signal, and k1 and k2 are constant values that satisfy the conditions k1+2·k2=1 and 0<k1<1, in response to the buck mode enable signal being asserted and the boost mode enable signal being asserted.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a circuit diagram exemplary of a four-switch switching stage of a buck-boost converter;

FIG. 2 is a time diagram exemplary of the coil current flowing through a coil coupled to the switching stage of FIG. 1 when the converter operates in a two-phase control mode;

FIG. 3 is a diagram exemplary of possible operating areas of a buck-boost converter;

FIG. 4 is a time diagram exemplary of possible time evolution of the coil current and of the converter clock signal for a buck-boost converter that operates in pure buck mode inside the dead zone;

FIG. 5 is a circuit block diagram exemplary of a buck-boost converter according to one or more embodiments of the present disclosure;

FIG. 6 is a circuit block diagram exemplary of possible implementation details of an error amplifier circuit of a buck-boost converter according to one or more embodiments of the present disclosure;

FIG. 7 is a schematic time diagram exemplary of the possible time evolution of signals in a buck-boost converter according to one or more embodiments of the present disclosure;

FIG. 8 is a circuit block diagram exemplary of possible implementation details of an operating mode selection circuit of a buck-boost converter according to one or more embodiments of the present disclosure;

FIG. 9 is a time diagram exemplary of the possible time evolution of signals in an operating mode selection circuit as exemplified in FIG. 8;

FIG. 10 is a circuit block diagram exemplary of possible implementation details of an analog voltage shifter circuit of a buck-boost converter according to one or more embodiments of the present disclosure; and

FIG. 11 is a time diagram exemplary of the possible time evolution of signals in a buck-boost converter according to one or more embodiments of the present disclosure.

### DETAILED DESCRIPTION OF ILLUSTRATIVE EMBODIMENTS

In the ensuing description, one or more specific details are illustrated, aimed at providing an in-depth understanding of examples of embodiments of this disclosure. The embodiments may be obtained without one or more of the specific details, or with other methods, components, materials, etc. In other cases, known structures, materials, or operations are not illustrated or described in detail so that certain aspects of embodiments will not be obscured.

Reference to “an embodiment” or “one embodiment” in the framework of the present disclosure is intended to indicate that a particular configuration, structure, or characteristic described in relation to the embodiment is included in at least one embodiment. Hence, phrases such as “in an embodiment” or “in one embodiment” that may be present in one or more points of the present disclosure do not necessarily refer to one and the same embodiment. Moreover, particular configurations, structures, or characteristics may be combined in any adequate way in one or more embodiments. The headings/references used herein are provided merely for convenience and hence do not define the extent of protection or the scope of the embodiments.

Throughout the figures annexed herein, unless the context indicates otherwise, like parts or elements are indicated with like references/numerals and a corresponding disclosure will not be repeated for the sake of brevity.

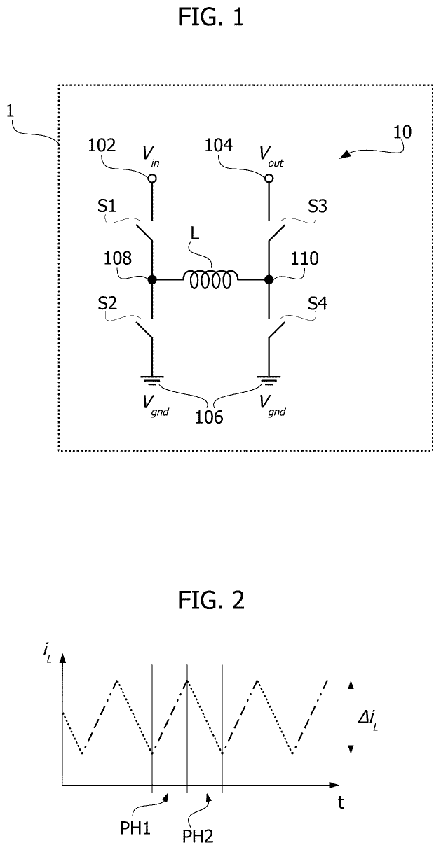

FIG. 1 is a circuit diagram exemplary of the switching stage 10 of a buck-boost converter 1, particularly a four-switch non-inverting buck-boost converter. The switching stage 10 comprises an input node 102 configured to receive an input voltage Vᵢₙ, an output node 104 configured to produce an output voltage Vₒᵤₜ, and a reference voltage node 106 (or ground node) configured to provide a reference voltage (or ground voltage) V_{gnd} (e.g., 0 V). A first half-bridge circuit (buck half-bridge circuit) is arranged between the input node 102 and the ground node 106, and includes a first high-side switch S1 arranged between the input node 102 and a first intermediate node (or switching node) 108, and a first low-side switch S2 arranged between the first switching node 108 and the ground node 106. A second half-bridge circuit (boost half-bridge circuit) is arranged between the output node 104 and the ground node 106, and includes a second high-side switch S3 arranged between the output node 104 and a second intermediate node (or switching node) 110, and a second low-side switch S4 arranged between the second switching node 110 and the ground node 106. A coil L (e.g., an inductor, possibly external to the integrated circuit that incorporates the converter 1) is arranged between the switching nodes 108 and 110.

FIG. 2 is a time diagram exemplary of the time evolution of the coil current i_{L} flowing through the coil L coupled to converter 1 when the converter operates in a two-phase control mode, i.e., when each switching cycle comprises two phases. In a first phase PH1, switches S1 and S4 are closed and switches S2 and S3 are open, so that the coil L is energized (e.g., magnetized, charged) by being coupled between the input node 102 at voltage Vᵢₙ and the ground node 106 at voltage V_{gnd}, with current i_{L} flowing from node 102 to node 106 as exemplified by the dash-and-dot line in FIG. 2. In a second phase PH2, switches S2 and S3 are closed and switches S1 and S4 are open, so that the coil L is de-energized (e.g., demagnetized, discharged) by being coupled between the ground node 106 at voltage V_{gnd} and the output node 104 at voltage Vₒᵤₜ, with current i_{L} flowing from node 106 to node 104 as exemplified by the dotted line in FIG. 2. The two-phase operation mode can be used for every combination of input and output voltages, since it does not depend on the difference between the input voltage Vᵢₙ and the output voltage Vₒᵤₜ. However, the two-phase operation mode may result in a high coil current ripple Δi_{L} and a high root mean square (rms) value of the coil current i_{L}, which lead to poor efficiency and low usability of this control scheme. For instance, with Vᵢₙ=Vₒᵤₜ=12 V, an inductance of the coil L equal to 2 μH and a switching frequency f_{SW} of about 1 MHz, the coil current ripple Δi_{L} may be about 3 A.

Some solutions aiming at reducing the coil current ripple Δi_{L} may rely on increasing the inductance value of the coil L or increasing the switching frequency of the converter 1, which however may result in a large area occupation on the printed circuit board (PCB), a high cost, low efficiency, or a combination of both.

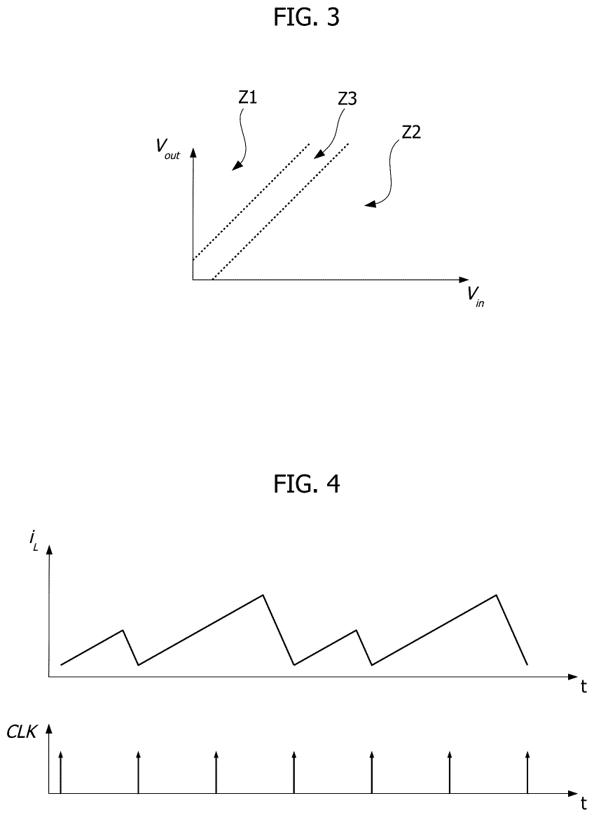

To overcome these drawbacks, a buck-boost converter can be forced to operate in pure buck mode by stopping the switching activity of the boost half-bridge circuit S3, S4 when Vᵢₙ>Vₒᵤₜ or in pure boost mode by stopping the switching activity of the buck half-bridge circuit S1, S2 when Vᵢₙ<Vₒᵤₜ. To this regard, FIG. 3 is a diagram exemplary of possible operating areas of a buck-boost converter, which depend on the values of the input voltage Vᵢₙ and of the output voltage Vₒᵤₜ. In particular, the buck-boost converter may operate in pure boost mode (i.e., with switch S1 steadily closed and switch S2 steadily open) when in the operating area Z1, and in pure buck mode (i.e., with switch S3 steadily closed and switch S4 steadily open) when in the operating area Z2. However, when operating in the operating area Z3 where Vᵢₙ≈Vₒᵤₜ, a so-called “dead zone” has to be taken into consideration, whose limits depend on the minimum turn-off time T_{off} and turn-on time Tₒₙ that can be managed by the gate drivers that drive the first and second half-bridge circuits (i.e., that drive switching of switches S1, S2, S3, S4).

In conventional fixed-frequency systems, the turn-on and turn-off timings suitable for operating in the dead zone Z3 cannot be provided by the gate drivers, resulting in some switching pulses possibly being skipped (e.g., missed) and the coil current ripple Δi_{L} increasing again as exemplified in the time diagrams of FIG. 4, which illustrate a possible time evolution of the coil current i_{L} and of the converter clock signal CLK for a buck-boost converter that operates in pure buck mode inside the dead zone Z3 of FIG. 3. This unwanted behavior (i.e., unexpected pulse skipping) may in turn cause system meta-stability and oscillations of the converter.

Some solutions to control a buck-boost converter in the dead zone Z3 may resort to a three-phase control scheme. In the third phase that follows the second phase, the coil L is coupled between the input node 102 and the output node 104 (i.e., switches S1 and S3 are closed, and switches S2 and S4 are open), with the coil current i_{L} being almost flat during such a third phase.

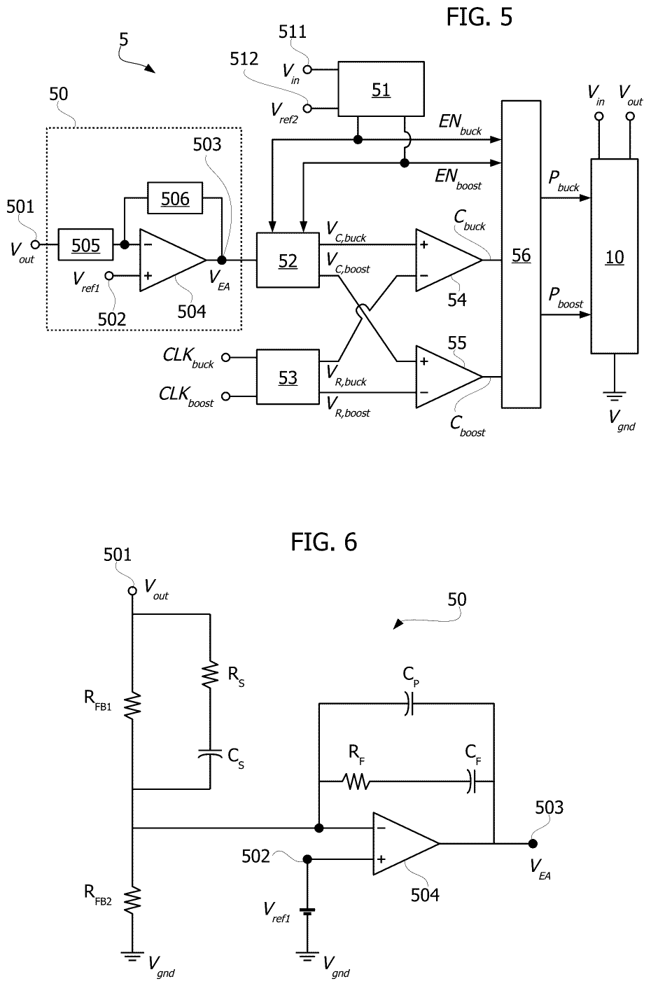

FIG. 5 is a circuit block diagram exemplary of a fixed-frequency, dual-ramp buck-boost non-inverting converter 5 according to one or more embodiments of the present disclosure. In particular, FIG. 5 is exemplary of the control architecture of converter 5. Converter 5 comprises an error amplifier circuit 50 (e.g., a differential amplifier) configured to compare the converter output voltage Vₒᵤₜ to a reference voltage V_{ref1} and produce an error signal V_{EA} indicative of the difference between V_{ref1} and Vₒᵤₜ. For instance, the error amplifier circuit 50 may comprise a first input node 501 configured to receive the converter output voltage Vₒᵤₜ, a second input node 502 configured to receive the reference voltage V_{ref1}, and an output node 503 configured to produce the error signal V_{EA}. The error amplifier circuit 50 may comprise an operational amplifier circuit 504 having a first (e.g., non-inverting) input coupled to node 502 to receive voltage V_{ref1} and a second (e.g., inverting) input coupled to node 501 via a feedback circuitry block 505 to receive voltage Vₒᵤₜ. The error amplifier circuit 50 may comprise another feedback circuitry block 506 coupled between the second input and the output node 503 to close the feedback loop of the amplifier circuit 50.

For instance, as exemplified in FIG. 6, the feedback circuitry block 505 may comprise a feedback voltage divider arranged between node 501 and the ground node (e.g., 106). The feedback voltage divider may comprise a first resistor R_{FB1} arranged between node 501 and the inverting input of amplifier 504, and a second resistor R_{FB2} arranged between the inverting input of amplifier 504 and the ground node. Resistor R_{FB2} may have a resistance value lower than the resistance value of resistor R_{FB1} (e.g., R_{FB2}=R_{FB1}/9). Additionally, the feedback circuitry block 505 may comprise a resistor R_{S} and a capacitor C_{S} arranged in series between node 501 and the inverting input of amplifier 504 (i.e., in parallel to resistor R_{FB1}). The feedback circuitry block 506 may comprise a capacitor C_{P} arranged between the inverting input of amplifier 504 and the output node 503 of amplifier 504. The feedback circuitry block 506 may further comprise a resistor R_{F} and a capacitor C_{F} arranged in series between the inverting input of amplifier 504 and the output node 503 of amplifier 504 (i.e., in parallel to capacitor C_{P}). The feedback loop of converter 5 operates so that, in steady state conditions, the voltage at the inverting input of amplifier 504, i.e., a scaled replica of the output voltage Vₒᵤₜ (e.g., Vₒᵤₜ/10 in case R_{FB2}=R_{FB1}/9) is equal to the reference voltage V_{ref1}.

Again, with reference to FIG. 5, converter 5 comprises a mode selection circuit 51 configured to produce a buck mode enable signal EN_{buck} and a boost mode enable signal EN_{boost} as a function of the value of the converter input voltage Vᵢₙ and (indirectly) of the value of converter output voltage Vₒᵤₜ. For instance, the mode selection circuit 51 may comprise a first input node 511 configured to receive the converter input voltage Vᵢₙ, and a second input node 512 configured to receive a reference voltage V_{ref2}. Reference voltage V_{ref2} may be equal to reference voltage V_{ref1}, or proportional to reference voltage V_{ref1}, or linearly dependent to reference voltage V_{ref1}, which in turn is related to the output voltage Vₒᵤₜ. Alternatively, reference voltage V_{ref2} may be set independently from reference voltage V_{ref1}, using proper trimming depending on the application.

The mode selection circuit 51 may be configured to assert (e.g., set to a high value, logic 1) the buck mode enable signal EN_{buck} in response to the input voltage Vᵢₙ being higher than a first threshold V_{th,buck}, and de-assert (e.g., set to a low value, logic 0) the buck mode enable signal EN_{buck} in response to the input voltage Vᵢₙ being lower than the first threshold V_{th,buck}. The mode selection circuit 51 may be configured to assert (e.g., set to a high value, logic 1) the boost mode enable signal EN_{boost} in response to the input voltage Vᵢₙ, being lower than a second threshold V_{th,boost}, and de-assert (e.g., set to a low value, logic 0) the boost mode enable signal EN_{boost} in response to the input voltage Vᵢₙ being higher than the second threshold V_{th,boost}. The second threshold V_{th,boost} may be higher than the first threshold V_{th,buck}. The buck mode enable signal EN_{buck} and the boost mode enable signal EN_{boost} are used to control the operating mode of converter 5 (e.g., pure buck, pure boost or buck-boost) as further disclosed in the following.

Converter 5 comprises a voltage shifter circuit 52 (e.g., an analog voltage shifter) configured to produce a buck control signal V_{C,buck} and a boost control signal V_{C,boost} as a function of the value of the error signal V_{EA}, and depending on the current operating mode of the converter 5 (e.g., pure buck, pure boost or buck-boost) determined by the values of signals EN_{buck} and EN_{boost}. Further details of voltage shifter circuit 52 are disclosed in the following.

Converter 5 comprises a dual ramp generator circuit 53 configured to produce a buck ramp signal V_{R,buck} and a boost ramp signal V_{R,boost} as a function of a buck clock signal CLK_{buck} and a boost clock signal CLK_{boost}, respectively. For instance, the ramp signals V_{R,buck} and V_{R,boost} may have a triangular or saw-tooth waveform produced according to the conventional operation of switching converters. The ramp signals V_{R,buck} and V_{R,boost} may be time-shifted with respect to one another. The ramp signals V_{R,buck} and V_{R,boost} may be used to control the buck half-bridge and the boost half-bridge of the switching stage 10 separately.

Converter 5 comprises a first comparator circuit 54 having a first (e.g., non-inverting) input configured to receive the buck control signal V_{C,buck} and a second (e.g., inverting) input configured to receive the buck ramp signal V_{R,buck} to produce a buck comparison signal C_{buck}. Therefore, the buck comparison signal C_{buck} may be asserted (e.g., set to a high logic value, logic 1) when V_{C,buck}>V_{R,buck} and de-asserted (e.g., set to a low logic value, logic 0) when V_{C,buck}<V_{R,buck}.

Converter 5 comprises a second comparator circuit 55 having a first (e.g., non-inverting) input configured to receive the boost control signal V_{C,boost} and a second (e.g., inverting) input configured to receive the boost ramp signal V_{R,boost} to produce a boost comparison signal C_{boost}. Therefore, the boost comparison signal C_{boost} may be asserted (e.g., set to a high logic value, logic 1) when V_{C,boost}>V_{R,boost} and de-asserted (e.g., set to a low logic value, logic 0) when V_{C,boost}<V_{R,boost}.

Converter 5 comprises a logic and driver circuit 56 (e.g., a control circuit) configured to receive signals EN_{buck}, EN_{boost}, C_{buck}, C_{boost}, CLK_{buck} and CLK_{boost} and produce, as a function thereof, a pulse-width modulated (PWM) buck signal P_{buck} and a pulse-width modulated (PWM) boost signal P_{boost} for controlling the commutation of switches S1, S2, S3 and S4, thereby determining the commutation duty-cycle D_{buck} of the buck half-bridge circuit (i.e., switches S1 and S2) and the commutation duty-cycle D_{boost} of the boost half-bridge circuit (i.e., switches S3 and S4). It is assumed herein that when the PWM buck signal P_{buck} is asserted, switch S1 is closed (e.g., on, conductive) and switch S2 is open (e.g., off, non-conductive), while when the PWM buck signal P_{buck} is de-asserted, switch S1 is open and switch S2 is closed. Similarly, when the PWM boost signal P_{boost} is asserted, switch S3 is open and switch S4 is closed, while when the PWM boost signal P_{boost} is de-asserted, switch S3 is closed and switch S4 is open.

In particular, the PWM signals P_{buck} and P_{boost} may be produced by circuit 56 according to the following logic. Provided that the enable signal EN_{buck} is asserted, signal P_{buck} may be asserted (e.g., a rising edge may be generated therein) in response to a pulse in the clock signal CLK_{buck}, and may be de-asserted (e.g., a falling edge may be generated therein) in response to the ramp signal V_{R,buck} exceeding the control signal V_{C,buck} (i.e., in response to the comparison signal C_{buck} being de-asserted). Otherwise, if the enable signal EN_{buck} is de-asserted, signal P_{buck} may be kept asserted independently from the value of the comparison signal C_{buck}.

Provided that the enable signal EN_{boost} is asserted, signal P_{boost} may be asserted (e.g., a rising edge may be generated therein) in response to a pulse in the clock signal CLK_{boost}, and may be de-asserted (e.g., a falling edge may be generated therein) in response to the ramp signal V_{R,boost} exceeding the control signal V_{C,boost} (i.e., in response to the comparison signal C_{boost} being de-asserted). Otherwise, if the enable signal EN_{boost} is de-asserted, signal P_{boost} may be kept de-asserted independently from the value of the comparison signal C_{boost}.

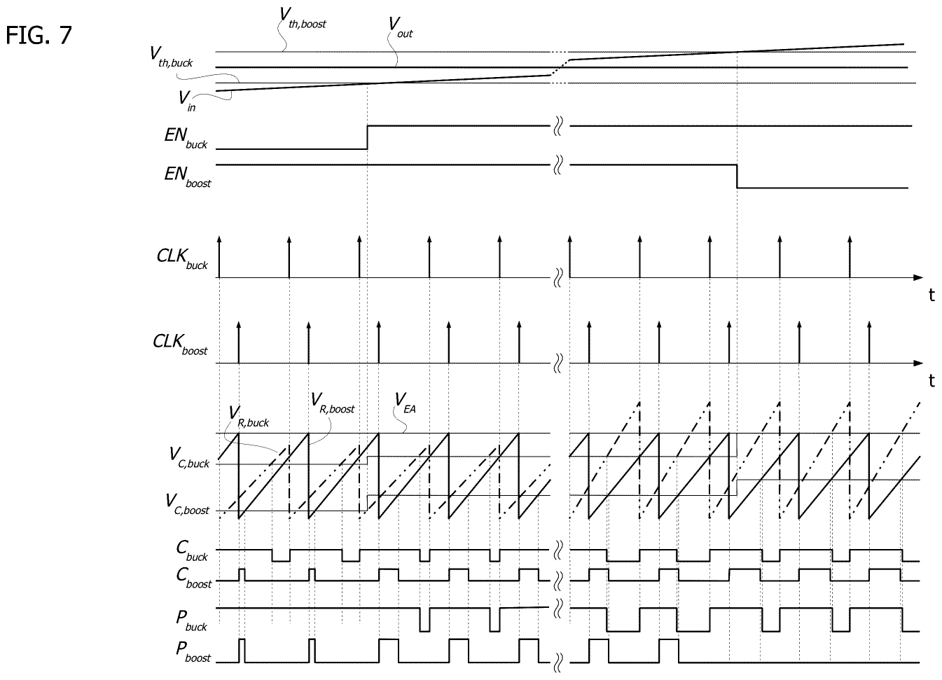

Operation of converter 5 as described with reference to FIG. 5 may be further understood by referring to FIG. 7, which illustrates time diagrams exemplary of signals Vᵢₙ, Vₒᵤₜ, V_{th,buck}, V_{th,boost}, EN_{buck}, EN_{boost}, CLK_{buck}, CLK_{boost}, V_{R,buck}, V_{R,boost}, V_{C,buck}, V_{C,boost}, C_{buck}, C_{boost}, P_{buck} and P_{boost} in the converter 5 when passing from boost mode operation, to buck-boost mode operation, to buck mode operation.

As exemplified in FIG. 7, when the input voltage Vᵢₙ is lower than the mode detector threshold V_{th,buck}, the buck enable signal EN_{buck} is de-asserted (e.g., low) and the boost enable signal EN_{boost} is asserted (e.g., high). The converter 5 operates in boost mode: signal P_{buck} is kept asserted—that is, switch S1 is kept conductive (on) and switch S2 is kept non-conductive (off)—while the pulses of clock signal CLK_{boost} and the value of comparison signal C_{boost} define the shape and duty-cycle of the boost PWM signal P_{boost} that controls switches S3 and S4.

As exemplified in FIG. 7, when the input voltage Vᵢₙ is higher than the mode detector threshold V_{th,boost}, the buck enable signal EN_{buck} is asserted (e.g., high) and the boost enable signal EN_{boost} is de-asserted (e.g., low). The converter 5 operates in buck mode: signal P_{boost} is kept de-asserted—that is, switch S3 is kept conductive (on) and switch S4 is kept non-conductive (off)—while the pulses of clock signal CLK_{buck} and the value of comparison signal C_{buck} define the shape and duty-cycle of the buck PWM signal P_{buck} that controls switches S1 and S2.

Still as exemplified in FIG. 7, when the input voltage Vᵢₙ is between the mode detector thresholds V_{th,buck} and V_{th,boost}, both signals EN_{buck} and EN_{boost} are asserted (e.g., high) and the converter 5 operates in buck-boost mode. Both the buck half-bridge circuit and the boost half-bridge circuit switch with different duty-cycles under control of PWM signals P_{buck} and P_{boost}, respectively. In buck-boost mode, the shape and duty-cycle of signal P_{buck} depend on the pulses of clock signal CLK_{buck} and on the value of comparison signal C_{buck}, while the shape and duty-cycle of signal P_{boost} depend on the pulses of clock signal CLK_{boost} and on the value of comparison signal C_{boost}.

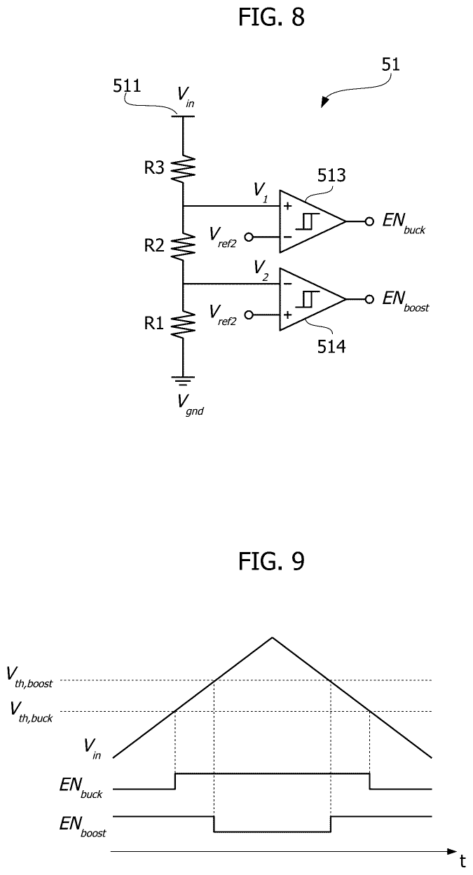

FIG. 8 is a circuit diagram exemplary of possible implementation details of a mode selection circuit 51 according to one or more embodiments. FIG. 9 is a time diagram exemplary of signals EN_{buck} and EN_{boost} as a function of voltage Vᵢₙ, and is exemplary of operation of the mode selection circuit 51. Mode selection circuit 51 may comprise a voltage divider circuit for producing two signals V₁ and V₂ proportional to the input voltage Vᵢₙ. For instance, a resistive voltage divider may comprise a first resistor R1, a second resistor R2 and a third resistor R3 arranged in series between the reference voltage node 106 (at voltage V_{gnd}, e.g., 0 V) and the input node 511 (at voltage Vᵢₙ). A first comparator circuit 513 (e.g., a comparator with hysteresis) may have a first (e.g., non-inverting) input coupled to a node intermediate resistors R3 and R2 to receive signal V₁, and a second (e.g., inverting) input coupled to node 512 to receive the reference voltage V_{ref2}. Signal EN_{buck} may be produced at the output of comparator 513. Therefore, signal EN_{buck} may be asserted if V_{ref2}<V₁ where V₁=Vᵢₙ·(R1+R2)/(R1+R2+R3) or, in other terms, if Vᵢₙ>V_{th,buck} where V_{th,buck}=V_{ref2}·(R1+R2+R3)/(R1+R2). A second comparator circuit 514 (e.g., a comparator with hysteresis) may have a first (e.g., inverting) input coupled to a node intermediate resistors R2 and R1 to receive signal V₂, and a second (e.g., non-inverting) input coupled to node 512 to receive the reference voltage V_{ref2}. Signal EN_{boost} may be produced at the output of comparator 514. Therefore, signal EN_{boost} may be asserted if V_{ref2}>V₂ where V₂=Vᵢₙ·R1/(R1+R2+R3) or, in other terms, if Vᵢₙ<V_{th,boost} where V_{th,boost}=V_{ref2}·(R1+R2+R3)/R1. From the equations above, it is also noted that V_{th,boost}>V_{th,buck}.

Therefore, the following operating regions can be identified, depending on the value of voltage Vᵢₙ, as exemplified in FIG. 9. If Vᵢₙ<V_{th,buck}, then EN_{buck}=0 and EN_{boost}=1, and converter 5 operates in boost mode. If V_{th,buck}<Vᵢₙ<V_{th,boost}, then EN_{buck}=1 and EN_{boost}=1, and converter 5 operates in buck-boost mode. If Vᵢₙ>V_{th,boost}, then EN_{buck}=1 and EN_{boost}=0, and converter 5 operates in buck mode. The values of the thresholds, V_{th,buck} and V_{th,boost}, define the limits of the buck-boost operating region and control the minimum Tₒₙ (respectively, T_{off}) that the converter can reach in boost (respectively, buck) operation mode. The size of the buck-boost operating region may be defined as a trade-off between the converter efficiency and the minimum Tₒₙ/T_{off} achievable by the gate drivers.

Providing smooth transitions between the three operating regions of converter 5 along with input voltage feed-forward is a desirable feature. Therefore, in one or more embodiments the analog voltage shifter circuit 52 may be configured to implement three different relationships between the control signals V_{C,buck} and V_{C,boost} and the error signal V_{EA}, so as to keep the error signal V_{EA} ideally constant throughout the ranges of Vᵢₙ and Vₒᵤₜ, as disclosed in the following.

Considering the step-down buck portion of converter 5, the input/output voltage relationship Vₒᵤₜ=D_{buck}·Vᵢₙ leads to the following steady state value for D_{buck} (equation 1):

$${D}_{b u c k} = {V}_{o u t} / {V}_{i n} \qquad ( 1 )$$

In a fixed-frequency architecture as considered herein, the value of the duty-cycle D_{buck} follows from the comparison of the buck control signal V_{C,buck} with the buck ramp signal V_{R,buck}, which shapes the buck PWM signal P_{buck}. If the height of the ramp signal V_{R,buck} (i.e., the difference between the ramp maximum value and the ramp minimum value, which is also equal to the ramp slew rate multiplied the clock period) is equal to the feed-forward voltage V_{FF}=Vᵢₙ/α (where α=Vₒᵤₜ/V_{ref1}; consequently, V_{FF}=V_{ref1}·Vᵢₙ/Vₒᵤₜ) and the control voltage V_{C,buck} is equal to the error signal V_{EA}, then the duty-cycle D_{buck} can be computed according to equation 2 below:

$${D}_{b u c k} = {V}_{E A} / {V}_{F F} \qquad ( 2 )$$

Combining equations 1 and 2 above, the steady state value of the error signal V_{EA} can be written as V_{EA}=Vₒᵤₜ/α and does not depend on the value of the converter input voltage Vᵢₙ.

Considering now the step-up boost portion of converter 5, the input/output voltage relationship Vₒᵤₜ=Vᵢₙ/(1−D_{boost}) leads to the following steady state value for D_{boost}: D_{boost}=1−Vᵢₙ/Vₒᵤₜ. In a fixed-frequency architecture as considered herein, the value of the duty-cycle D_{boost} follows from the comparison of the boost control signal V_{C,boost} with the boost ramp signal V_{R,boost}, which shapes the boost PWM signal P_{boost}. If the height of the ramp signal V_{R,boost} is equal to the reference voltage V_{ref1}=Vₒᵤₜ/α and the control voltage V_{C,boost} is equal to the difference between the error signal V_{EA} and the feed-forward voltage V_{FF} (V_{C,boost}=V_{EA}−V_{FF}), then the duty-cycle D_{boost} can be computed as: D_{boost}=(V_{EA}−V_{FF})/V_{ref1}. The steady state value of the error signal V_{EA} can thus be written as V_{EA}=Vₒᵤₜ/α, which is the same obtained previously for the step-down buck converter, and does not depend on the value of the converter input voltage Vᵢₙ.

In one or more embodiments, the analog voltage shifter circuit 52 may thus be configured to produce control voltages V_{C,buck} and V_{C,boost} so that, when converter 5 operates in the buck-boost mode, the error signal V_{EA} maintains a value V_{EA}=Vₒᵤₜ/α, which facilitates smooth transitions between the converter operating modes.

Considering the buck-boost operation of converter 5, the input/output voltage relationship can be written according to equation 3 below:

$${V}_{o u t} = ( {D}_{b u c k} / ( 1 - {D}_{b o o s t} ) ) \cdot {V}_{i n} \qquad ( 3 )$$

If the height of the buck ramp signal V_{R,buck} is equal to the feed-forward voltage V_{FF}=Vᵢₙ/α (as considered before) and the buck control voltage V_{C,buck} is shifted with respect to the error signal V_{EA} by a quantity k2·V_{ref1} (i.e., V_{C,buck}=V_{EA}−k2·V_{ref1} with k2 being a constant), then the duty-cycle D_{buck} can be computed according to equation 4 below:

$${D}_{b u c k} = ( {V}_{E A} - k 2 \cdot {V}_{ref 1} ) / {V}_{FF} \qquad ( 4 )$$

Similarly, if the height of the boost ramp signal V_{R,boost} is equal to reference voltage V_{ref1} (as considered before) and the boost control voltage V_{C,boost} is shifted with respect to the error signal V_{EA} by a quantity (k1+k2)·V_{ref1} (i.e., V_{C,boost}=V_{EA}−(k1+k2)·V_{ref1} or, in other terms, V_{C,buck}−V_{C,boost}=k1·V_{ref1}, with k1 being a constant), then the duty-cycle D_{boost} can be computed according to equation 5 below:

$${D}_{b o o s t} = ( {V}_{E A} - ( k 1 + k 2 ) \cdot {V}_{ref 1} ) / {V}_{ref 1} \qquad ( 5 )$$

Combining equations 4 and 5 into equation 3 above, the steady state value of the error signal V_{EA} can be written according to equation 6 below:

$${V}_{E A} = {V}_{ref 1} \cdot ( 1 + k 1 + 2 \cdot k 2 ) / 2 \qquad ( 6 )$$

If the condition k1+2·k2=1 holds true, and a value of k1 between 0 and 1 is selected (i.e., 0<k1<1), the steady state value of the error signal V_{EA} can be written as V_{EA}=Vₒᵤₜ/α, which is the same obtained previously for the step-down buck conversion and the step-up boost conversion, resulting in continuity of operation throughout the three operating modes of converter 5.

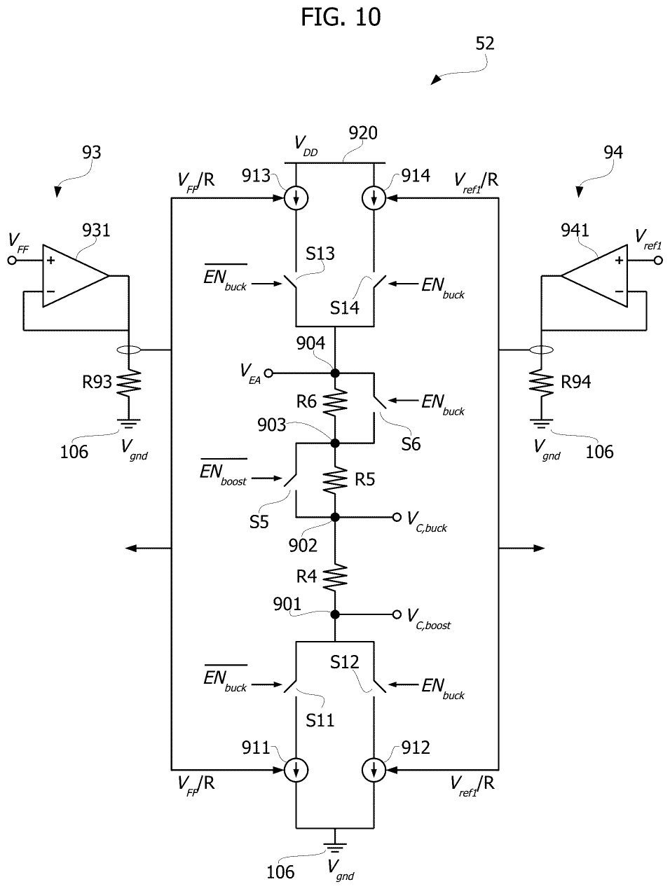

FIG. 10 is a circuit diagram exemplary of possible implementation details of a voltage shifter circuit 52 according to one or more embodiments, which operates according to the principle disclosed in the foregoing.

As exemplified in FIG. 10, voltage shifter circuit 52 may comprise a voltage divider circuit including a first resistor R4 arranged between node 901 and node 902, a second resistor R5 arranged between node 902 and node 903, and a third resistor R6 arranged between node 903 and node 904. The second resistor R5 may be by-passed via a switch S5 arranged between node 902 and node 903 (i.e., in parallel to resistor R5); switch S5 is controlled by the complement of the boost enable signal EN_{boost}, e.g., switch S5 is closed when signal EN_{boost} is de-asserted and is open when signal EN_{boost} is asserted. The third resistor R6 may be by-passed via a switch S6 arranged between node 903 and node 904 (i.e., in parallel to resistor R6); switch S6 is controlled by the buck enable signal EN_{buck}, e.g., switch S6 is closed when signal EN_{buck} is asserted and is open when signal EN_{buck} is de-asserted. Node 904 is configured to receive the error signal V_{EA} from the error amplifier circuit 50. Node 902 is configured to produce the buck control signal V_{C,buck} and node 901 is configured to produce the boost control signal V_{C,boost}.

As exemplified in FIG. 10, a first current generator 911 may be selectively coupled between node 901 and the ground node 106 at voltage V_{gnd} by closing a switch S11 that is controlled by the complement of the buck enable signal EN_{buck}, e.g., switch S11 is closed when signal EN_{buck} is de-asserted and is open when signal EN_{buck} is asserted. The first current generator 911 may be configured to sink from node 901 a current proportional to the feed-forward voltage V_{FF}, as further disclosed in the following. A second current generator 912 may be selectively coupled between node 901 and the ground node 106 at voltage V_{gnd} by closing a switch S12 that is controlled by the buck enable signal EN_{buck}, e.g., switch S12 is closed when signal EN_{buck} is asserted and is open when signal EN_{buck} is de-asserted. In other words, switches S11 and S12 operate complementarily. The second current generator 912 may be configured to sink from node 901 a current proportional to the reference voltage V_{ref1}, as further disclosed in the following.

As exemplified in FIG. 10, a third current generator 913 may be selectively coupled between a supply voltage node 920 at voltage V_{DD} and node 904 by closing a switch S13 that is controlled by the complement of the buck enable signal EN_{buck}, e.g., switch S13 is closed when signal EN_{buck} is de-asserted and is open when signal EN_{buck} is asserted. The third current generator 913 may be configured to source to node 904 a current proportional to the feed-forward voltage V_{FF}, as further disclosed in the following. A fourth current generator 914 may be selectively coupled between the supply voltage node 920 at voltage V_{DD} and node 904 by closing a switch S14 that is controlled by the buck enable signal EN_{buck}, e.g., switch S14 is closed when signal EN_{buck} is asserted and is open when signal EN_{buck} is de-asserted. In other words, switches S13 and S14 operate complementarily; switch S13 operates synchronously with switch S11; and switch S14 operates synchronously with switch S12. The fourth current generator 914 may be configured to source to node 904 a current proportional to the reference voltage V_{ref1}, as further disclosed in the following.

As exemplified in FIG. 10, voltage shifter circuit 52 may comprise a first voltage-to-current converter circuit 93 configured to produce a signal proportional to the feed-forward voltage V_{FF} to control the first current generator 911 and the third current generator 913. In particular, circuit 93 may comprise an operational amplifier circuit 931 configured to receive voltage V_{FF} at its non-inverting input, and arranged in a voltage buffer configuration (i.e., having its inverting input directly connected to its output) to pass voltage V_{FF} to a first terminal of a resistor R93 having a resistance value equal to R. The second terminal of resistor R93 is coupled to the ground node 106 at voltage V_{gnd}. By sensing the current flowing through resistor R93, a signal proportional to V_{FF} (in particular, equal to V_{FF}/R) is produced and used to control the current generators 911 and 913.

As exemplified in FIG. 10, voltage shifter circuit 52 may comprise a second voltage-to-current converter circuit 94 configured to produce a signal proportional to the reference voltage V_{ref1} to control the second current generator 912 and the fourth current generator 914. In particular, circuit 94 may comprise an operational amplifier circuit 941 configured to receive voltage V_{ref1} at its non-inverting input, and arranged in a voltage buffer configuration (i.e., having its inverting input directly connected to its output) to pass voltage V_{ref1} to a first terminal of a resistor R94 having a resistance value equal to R. The second terminal of resistor R94 is coupled to the ground node 106 at voltage V_{gnd}. By sensing the current flowing through resistor R94, a signal proportional to V_{ref1} (in particular, equal to V_{ref1}/R) is produced and used to control the current generators 912 and 914.

In one or more embodiments as exemplified in FIG. 10, resistor R4 may have a resistance value equal to k1·R, resistor R5 may have a resistance value equal to k2·R, and resistor R6 may have a resistance value equal to (1−k1−k2)·R. By resorting to such dimensioning criteria, and considering that the topology of the analog voltage shifter circuit 52 is determined by the operation mode of converter 5 (buck, boost or buck-boost) via switches S5, S6, S11, 512, S13 and S14, operation of converter 5 as previously discussed can be achieved. For instance, when the converter 5 operates in buck mode, resistors R5 and R6 are by-passed via closed switches S5 and S6, node 902 is directly coupled to node 904 and thus V_{C,buck}=V_{EA}. When the converter 5 operates in boost mode, both switches S5 and S6 are open, and thus V_{C,boost}=V_{EA}−(R4+R5+R6)·V_{FF}/R=V_{EA}−(k1·R+k2·R+(1−k1−k2)·R)·V_{FF}/R=V_{EA}−V_{FF}. When the converter 5 operates in buck-boost mode, switch S5 is open and switch S6 is closed, and thus:

$${V}_{C , buck} = {V}_{E A} - {R}_{5} \cdot {V}_{ref 1} / R = {V}_{E A} - k 2 \cdot R \cdot {V}_{ref 1} / R = {V}_{E A} - k 2 \cdot {V}_{ref 1}$$

$${V}_{C , boost} = {V}_{E A} - ( {R}_{4} + {R}_{5} ) \cdot {V}_{ref 1} / R = {V}_{E A} - ( k 1 + k 2 ) \cdot R \cdot {V}_{ref 1} / R = {V}_{E A} - ( k 1 + k 2 ) \cdot {V}_{ref 1}$$

Since all the voltage shifts are proportional to resistor ratios, high accuracy can be achieved in an integrated circuit including converter 5 by matching the resistors.

Table I at the end of the description provides examples of the minimum Tₒₙ and T_{off} times for all operation modes of buck and boost bridges in accordance with some embodiments. As far as buck and boost modes are concerned, the minimum T_{off} and Tₒₙ, respectively, may be guaranteed by the mode detector thresholds. On the other hand, the minimum T_{off} and Tₒₙ within the buck-boost operating region are guaranteed by selecting the value of the constant k1. Therefore, in order to improve the converter efficiency, the buck-boost operating region (where all the four switches S1, S2, S3 and S4, e.g., power MOS transistors, are switching) should be as little as possible, while the buck and boost regions (where only two of the four switches S1, S2, S3 and S4 are switching) should be extended. By knowing the minimum on/off time managed by the gate drivers (e.g., included in the driver circuit 56), it is possible to avoid by design the dead zone and improving converter efficiency, by selecting the proper values of k1 and mode detector thresholds.

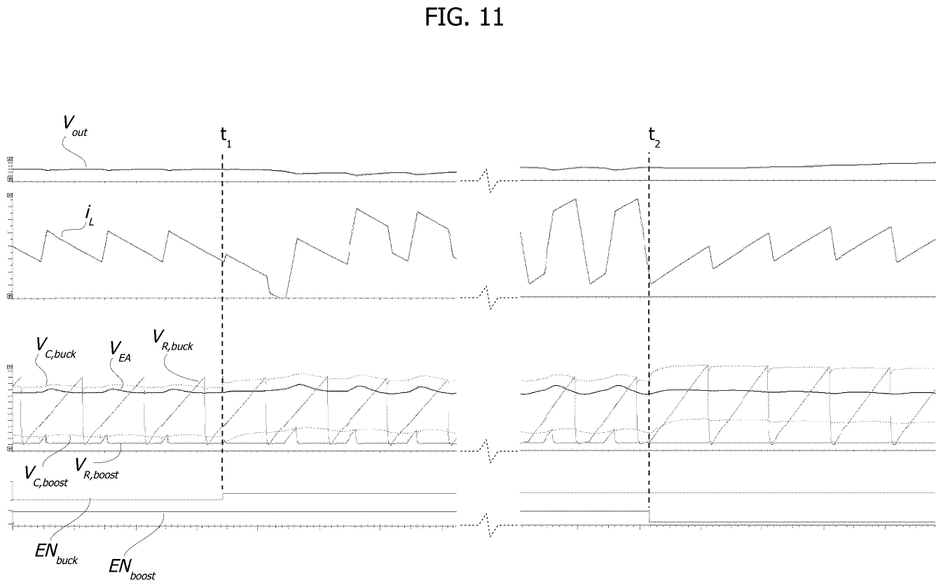

Operation of one or more embodiments of converter 5 may be further understood by referring to FIG. 11, which illustrates time diagrams exemplary of signals Vₒᵤₜ, i_{L}, V_{R,buck}, V_{R,boost}, V_{C,buck}, V_{C,boost}, V_{EA}, EN_{buck} and EN_{boost} in the converter 5 when passing from boost mode operation (until instant t₁, with EN_{buck}=0 and EN_{boost}=1), to buck-boost mode operation (from instant t₁ to instant t₂, with EN_{buck}=1 and EN_{boost}=1), to buck mode operation (from instant t₂, with EN_{buck}=1 and EN_{boost}=0).

One or more embodiments may thus provide a DC-DC buck-boost converter having improved efficiency that relies on pure buck operation mode and pure boost operation mode only, avoids operation of the converter in the dead-zone, reduces coil current ripple in the buck-boost region, or both. Without prejudice to the underlying principles, the details and embodiments may vary, even significantly, with respect to what has been described by way of example only, without departing from the extent of protection.

TABLE I

| | Boost mode | Buck-boost mode | Buck mode |
|---|---|---|---|
| Tₒₙ (boost bridge) | ${T}_{SW} \cdot ( 1 - \frac{{V}_{i n}}{{V}_{o u t}} )$ | ${T}_{SW} \cdot ( \frac{1 - k 1}{2} )$ | S₄ always OFF |
| T_{off} (buck bridge) | S₁ always ON | ${T}_{SW} \cdot [ 1 - ( \frac{1 + k 1}{2} ) \cdot \frac{{V}_{o u t}}{{V}_{i n}} ]$ | ${T}_{SW} \cdot ( 1 - \frac{{V}_{o u t}}{{V}_{i n}} )$ |

What is claimed is:

1. A DC-DC converter control system, comprising:
an operation mode selection circuit configured to:
compare an input voltage to a lower threshold and an upper threshold,
assert a buck mode enable signal in response to the input voltage exceeding the lower threshold and de-assert the buck mode enable signal in response to the input voltage falling below the lower threshold, and
assert a boost mode enable signal in response to the input voltage being below the upper threshold and de-assert the boost mode enable signal in response to the input voltage exceeding the upper threshold; and
a voltage shifter circuit configured to:
receive an error signal representing a difference between an output voltage and a reference voltage,
generate a buck control signal and a boost control signal based on the error signal, the buck mode enable signal, and the boost mode enable signal,
wherein the voltage shifter circuit applies different relationships between the buck control signal, the boost control signal, and the error signal based on the states of the buck mode enable signal and the boost mode enable signal, and
wherein the relationships are selected to maintain a constant error signal value across transitions between operating modes.

2. The DC-DC converter control system of claim 1, wherein the voltage shifter circuit is configured to:
set the buck control signal equal to the error signal in response to the buck mode enable signal being asserted and the boost mode enable signal being de-asserted;
set the boost control signal equal to a difference between the error signal and a feedforward voltage in response to the buck mode enable signal being de-asserted and the boost mode enable signal being asserted; and
set the buck control signal equal to a difference between the error signal and a product of a first constant and the reference voltage, and set the boost control signal equal to a difference between the error signal and a product of a sum of the first constant and a second constant and the reference voltage, in response to the buck mode enable signal being asserted and the boost mode enable signal being asserted, wherein the first constant and the second constant satisfy a predetermined relationship.

3. The DC-DC converter control system of claim 1, further comprising:
a ramp generator circuit configured to produce a buck ramp signal as a function of a buck clock signal and produce a boost ramp signal as a function of a boost clock signal; and
a control circuit configured to:
compare the buck control signal to the buck ramp signal;
assert a buck pulse-width modulated control signal in response to a pulse in the buck clock signal and de-assert the buck pulse-width modulated control signal in response to the buck ramp signal being higher than the buck control signal, provided that the buck mode enable signal is asserted;
retain the buck pulse-width modulated control signal asserted, provided that the buck mode enable signal is de-asserted;
compare the boost control signal to the boost ramp signal;
assert a boost pulse-width modulated control signal in response to a pulse in the boost clock signal and de-assert the boost pulse-width modulated control signal in response to the boost ramp signal being higher than the boost control signal, provided that the boost mode enable signal is asserted; and
retain the boost pulse-width modulated control signal de-asserted, provided that the boost mode enable signal is de-asserted.

4. The DC-DC converter control system of claim 1, wherein the voltage shifter circuit comprises:
a voltage divider circuit including a first node, a second node, a third node, a fourth node, a first resistor coupled between the first node and the second node, a second resistor coupled between the second node and the third node, and a third resistor coupled between the third node and the fourth node, wherein the first node is configured to produce the boost control signal, the second node is configured to produce the buck control signal, and the fourth node is configured to receive the error signal;
a first current generator circuit configured to supply to the voltage divider circuit a current proportional to a feedforward voltage;
a second current generator circuit configured to supply to the voltage divider circuit a current proportional to the reference voltage; and
a plurality of switches controllable by the buck mode enable signal and the boost mode enable signal.

5. The DC-DC converter control system of claim 4, wherein the plurality of switches are arranged to:
couple the voltage divider circuit to the first current generator circuit to receive the current proportional to the feedforward voltage in response to the buck mode enable signal being de-asserted;
couple the voltage divider circuit to the second current generator circuit to receive the current proportional to the reference voltage in response to the buck mode enable signal being asserted;
bypass the second resistor in response to the boost mode enable signal being de-asserted; and
bypass the third resistor in response to the buck mode enable signal being asserted.

6. The DC-DC converter control system of claim 4, wherein the voltage shifter circuit further comprises:
a first voltage-to-current converter arrangement configured to sense the feedforward voltage and control the first current generator circuit; and
a second voltage-to-current converter arrangement configured to sense the reference voltage and control the second current generator circuit.

7. The DC-DC converter control system of claim 1, wherein the operation mode selection circuit comprises:
a voltage divider circuit configured to receive the input voltage and produce a first signal proportional to the input voltage and a second signal proportional to the input voltage, wherein a proportionality factor of the first signal to the input voltage is higher than a proportionality factor of the second signal to the input voltage;
a first comparator configured to assert the buck mode enable signal in response to the first signal being higher than a further reference voltage, and de-assert the buck mode enable signal in response to the first signal being lower than the further reference voltage; and
a second comparator configured to assert the boost mode enable signal in response to the further reference voltage being higher than the second signal, and de-assert the boost mode enable signal in response to the further reference voltage being lower than the second signal.

8. A method of operating a DC-DC converter, comprising:
comparing an input voltage to a lower threshold and an upper threshold;
asserting a buck mode enable signal in response to the input voltage exceeding the lower threshold and de-asserting the buck mode enable signal in response to the input voltage falling below the lower threshold;
asserting a boost mode enable signal in response to the input voltage being below the upper threshold and de-asserting the boost mode enable signal in response to the input voltage exceeding the upper threshold;
generating an error signal representing a difference between an output voltage and a reference voltage;
producing a buck control signal and a boost control signal based on the error signal, the buck mode enable signal, and the boost mode enable signal;
applying different relationships between the buck control signal, the boost control signal, and the error signal based on states of the buck mode enable signal and the boost mode enable signal, wherein the relationships are selected to maintain a constant error signal value across transitions between operating modes; and
controlling a switching stage based on the buck control signal and the boost control signal to generate the output voltage.

9. The method of claim 8, further comprising:
generating a buck ramp signal based on a buck clock signal;
generating a boost ramp signal based on a boost clock signal;
comparing the buck control signal to the buck ramp signal;
comparing the boost control signal to the boost ramp signal;
asserting a buck pulse-width modulated control signal in response to a pulse in the buck clock signal and de-asserting the buck pulse-width modulated control signal in response to the buck ramp signal being higher than the buck control signal, provided that the buck mode enable signal is asserted;
retaining the buck pulse-width modulated control signal asserted, provided that the buck mode enable signal is de-asserted;
asserting a boost pulse-width modulated control signal in response to a pulse in the boost clock signal and de-asserting the boost pulse-width modulated control signal in response to the boost ramp signal being higher than the boost control signal, provided that the boost mode enable signal is asserted; and
retaining the boost pulse-width modulated control signal de-asserted, provided that the boost mode enable signal is de-asserted.

10. The method of claim 8, wherein producing the buck control signal and the boost control signal comprises:
setting the buck control signal equal to the error signal in response to the buck mode enable signal being asserted and the boost mode enable signal being de-asserted;
setting the boost control signal equal to a difference between the error signal and a feedforward voltage in response to the buck mode enable signal being de-asserted and the boost mode enable signal being asserted; and
setting the buck control signal equal to a difference between the error signal and a product of a first constant and the reference voltage, and setting the boost control signal equal to a difference between the error signal and a product of a sum of the first constant and a second constant and the reference voltage, in response to the buck mode enable signal being asserted and the boost mode enable signal being asserted, wherein the first constant and the second constant satisfy a predetermined relationship.

11. The method of claim 8, wherein comparing the input voltage to the lower threshold and the upper threshold comprises:
generating a first signal proportional to the input voltage with a first proportionality factor;
generating a second signal proportional to the input voltage with a second proportionality factor lower than the first proportionality factor;
comparing the first signal to a further reference voltage to generate the buck mode enable signal; and
comparing the second signal to the further reference voltage to generate the boost mode enable signal.

12. The method of claim 11, wherein:
the buck mode enable signal is asserted in response to the first signal being higher than the further reference voltage, and de-asserted in response to the first signal being lower than the further reference voltage; and
the boost mode enable signal is asserted in response to the further reference voltage being higher than the second signal, and de-asserted in response to the further reference voltage being lower than the second signal.

13. The method of claim 8, wherein the lower threshold and the upper threshold are selected to avoid a dead zone of operation in which minimum on-time or minimum off-time constraints would cause pulse skipping.

14. The method of claim 8, further comprising:
operating the DC-DC converter in a buck mode in response to the buck mode enable signal being asserted and the boost mode enable signal being de-asserted;
operating the DC-DC converter in a boost mode in response to the buck mode enable signal being de-asserted and the boost mode enable signal being asserted; and
operating the DC-DC converter in a buck-boost mode in response to both the buck mode enable signal and the boost mode enable signal being asserted.

15. A DC-DC converter circuit, comprising:
a switching stage having a buck half-bridge circuit including a first high-side switch and a first low-side switch, and a boost half-bridge circuit including a second high-side switch and a second low-side switch;
a coil coupled between the buck half-bridge circuit and the boost half-bridge circuit;
an error amplifier circuit configured to generate an error signal based on a difference between an output voltage and a reference voltage;
an operation mode selection circuit configured to:
compare an input voltage to a lower threshold and an upper threshold,
assert a buck mode enable signal in response to the input voltage exceeding the lower threshold and de-assert the buck mode enable signal in response to the input voltage falling below the lower threshold, and
assert a boost mode enable signal in response to the input voltage being below the upper threshold and de-assert the boost mode enable signal in response to the input voltage exceeding the upper threshold;
a voltage shifter circuit configured to generate a buck control signal and a boost control signal based on the error signal, the buck mode enable signal, and the boost mode enable signal, wherein the voltage shifter circuit applies different relationships between the buck control signal, the boost control signal, and the error signal based on states of the buck mode enable signal and the boost mode enable signal;
a ramp generator circuit configured to generate a buck ramp signal based on a buck clock signal and a boost ramp signal based on a boost clock signal; and
a control circuit configured to generate a buck pulse-width modulated control signal and a boost pulse-width modulated control signal to control the switching stage based on comparisons between the control signals and the ramp signals.

16. The DC-DC converter circuit of claim 15, wherein the control circuit is configured to:
assert the buck pulse-width modulated control signal in response to a pulse in the buck clock signal and de-assert the buck pulse-width modulated control signal in response to the buck ramp signal being higher than the buck control signal, provided that the buck mode enable signal is asserted;
retain the buck pulse-width modulated control signal as asserted, provided that the buck mode enable signal is de-asserted;
assert the boost pulse-width modulated control signal in response to a pulse in the boost clock signal and de-assert the boost pulse-width modulated control signal in response to the boost ramp signal being higher than the boost control signal, provided that the boost mode enable signal is asserted; and
retain the boost pulse-width modulated control signal as de-asserted, provided that the boost mode enable signal is de-asserted.

17. The DC-DC converter circuit of claim 15, wherein the voltage shifter circuit is configured to:
set the buck control signal equal to the error signal in response to the buck mode enable signal being asserted and the boost mode enable signal being de-asserted;
set the boost control signal equal to a difference between the error signal and a feedforward voltage in response to the buck mode enable signal being de-asserted and the boost mode enable signal being asserted; and
set the buck control signal equal to a difference between the error signal and a product of a first constant and the reference voltage, and set the boost control signal equal to a difference between the error signal and a product of a sum of the first constant and a second constant and the reference voltage, in response to the buck mode enable signal being asserted and the boost mode enable signal being asserted, wherein the first constant and the second constant satisfy a predetermined relationship.

18. The DC-DC converter circuit of claim 15, wherein the voltage shifter circuit comprises:
a voltage divider circuit including a first node, a second node, a third node, a fourth node, a first resistor coupled between the first node and the second node, a second resistor coupled between the second node and the third node, and a third resistor coupled between the third node and the fourth node, wherein the first node is configured to produce the boost control signal, the second node is configured to produce the buck control signal, and the fourth node is configured to receive the error signal;
a first current generator circuit configured to supply to the voltage divider circuit a current proportional to a feedforward voltage;
a second current generator circuit configured to supply to the voltage divider circuit a current proportional to the reference voltage; and
a plurality of switches controllable by the buck mode enable signal and the boost mode enable signal.

19. The DC-DC converter circuit of claim 18, wherein the plurality of switches are arranged to:
couple the voltage divider circuit to the first current generator circuit to receive the current proportional to the feedforward voltage in response to the buck mode enable signal being de-asserted;
couple the voltage divider circuit to the second current generator circuit to receive the current proportional to the reference voltage in response to the buck mode enable signal being asserted;
bypass the second resistor in response to the boost mode enable signal being de-asserted; and
bypass the third resistor in response to the buck mode enable signal being asserted.

20. The DC-DC converter circuit of claim 15, wherein the operation mode selection circuit comprises:
a voltage divider circuit configured to receive the input voltage and produce a first signal proportional to the input voltage and a second signal proportional to the input voltage, wherein a proportionality factor of the first signal to the input voltage is higher than a proportionality factor of the second signal to the input voltage;
a first comparator configured to assert the buck mode enable signal in response to the first signal being higher than a further reference voltage, and de-assert the buck mode enable signal in response to the first signal being lower than the further reference voltage; and
a second comparator configured to assert the boost mode enable signal in response to the further reference voltage being higher than the second signal, and de-assert the boost mode enable signal in response to the further reference voltage being lower than the second signal.
